(19) United States
(12) Patent Application Publication
(10) Pub. No.: US 2008/0230027 A1
(43) Pub. Date: Sep. 25, 2008

(54) Vct Control Module with Intelligence

(75) Inventors: Roger T. Simpson, Ithaca, NY (US); Danny R. Taylor, Freeville, NY (US)

Correspondence Address: BORGWARNER INC.;c/o Brown & Michaels, PC, 400 M&T Bank Building, 118 N. Tioga Street, Ithaca, NY, 14850, US

(73) Assignee: BORGWARNER INC., Auburn Hills, MI (US)

(21) Appl. No.: 12/092,602

(22) PCT Filed: Nov. 20, 2006
(86) PCT No.: PCT/US06/61077

§ 371 Date: May 5, 2008

(51) Int. Cl. F01L 1/344; G06F 19/00; F16D 3/10

(52) U.S. Cl. 123/90.17; 701/102; 464/2

(57) ABSTRACT

A variable cam timing control module for an internal combustion engine having at least one cam position sensor, at least one solenoid to actuate a cam phasing device, a driven outer cam sprocket position sensor and a microcontroller. The microcontroller may receive a set point angle signal from the engine's Electronic Control Unit, which it compares with input signals from the driven outer cam sprocket position sensor and the at least one cam position sensor to determine the proper cam phase angle. The microcontroller then sends a signal to the at least one solenoid to adjust the corresponding cam phasing device so that the cam phase angle matches the commanded set point.

### FIELD OF THE INVENTION

The invention pertains to a variable cam timing control device for the power transmission system of an internal combustion engine. More particularly, the invention pertains to a variable cam timing control module that performs the functions performed by sensors, actuators and microcontrollers conventionally located in separate locations throughout the engine compartment.

### BACKGROUND OF THE INVENTION

In a closed loop power transmission system, variable cam timing (“VCT”) is the system that measures the angular displacement, or phase angle, of a camshaft, relative to the crankshaft to which it is operatively connected and then alters the phase angle to adjust various engine characteristics in response to demands for either an increase or a reduction in power. Typically, there is a feedback loop in which the desired values of such engine characteristics are measured against their existing values, and changes are effected inside the engine in response to any variances. To accomplish this, modern automobiles usually have one or more Electronic Control Units (“ECU”) which constantly analyze data fed into them from various parts of the engine, other parts of the automobile and ambient conditions (exhaust gas sensors, pressure and temperature sensors, etc.). A control signal is then emitted in response to such data. For example, with regard to VCT systems, as changes occur in engine and/or external conditions, the angular displacement between the camshaft and the crankshaft are adjusted accordingly.

A VCT system includes a cam phasing control device, sometimes referred to as a phaser, control valves, control valve actuators and control circuitry. VCT is a process that refers to controlling and/or varying the angular relationship (the “phase”) between the drive shaft and one or more camshafts which control the engine's intake and exhaust valves. Phase is defined as the relative angular position between the crankshaft or driven outer sprocket and a camshaft. The phaser mounts to the front of the cam and typically consists of a rotor, check valves and a spool valve. The rotor is the inner part of the phaser which is attached to the end of the camshaft. In response to input signals, a solenoid, often a variable force solenoid (“VFS”), will move the position of the phaser rotor, which in turn, adjusts the camshaft to either advance or retard engine timing.

The conventional method of connecting a system, such as a VCT system, to the control module is to run a set of wires from each solenoid, valve, actuator or motor and each sensor back to the engine's ECU. As a result of the increasing complexity of automotive engines, the number of wires feeding into the ECU may become unmanageable. For example, some ECU's may have approximately 150 to 200 externally-connected wires. With the increased complexity of engines and the need to rapidly respond to increasing amounts of input data from numerous sensors, it becomes more and more difficult for the ECU to efficiently manage all of these functional elements.

Various attempts have been made to address the problem of managing such increased engine complexity in an efficient and economical manner. For example, U.S. Pat. No. 5,353,755 to Matsuo et al. discloses a variable valve timing control system incorporated into the front cover of a V-type internal combustion engine. The patent discloses a V-type engine comprising a plurality of hydraulically actuated valve operation mode control actuators for two cylinder banks. A hydraulic fluid network is disposed between a main gallery of the cylinder block and a plurality of hydraulic valve operation mode control actuators, and includes a single control valve, which is common to all of the hydraulic valve operation mode control actuators. This control valve is attached to a casing adapted to house a drive system connecting the engine camshafts to the engine crankshaft. The casing also has internal passages forming a part of the hydraulic fluid network between the control valve and the plurality of hydraulic valve operation mode control actuators. However, the '755 patent does not disclose or suggest the incorporation of sensors or a VCT control device as a single unit within the front cover of the engine.

It will be understood by one skilled in the art that in the context of this invention the term “front cover” refers to the cover over the components of the power transmission system of the engine—the camshaft drive element(s) (gear, sprocket or pulley) and cam phaser(s), the crankshaft end and drive element (gear, sprocket or pulley), and the power transmission component (chain, belt or gears) connecting the crankshaft drive to the cam drive(s). In the traditional fore-and-aft engine, this cover would be located at the front of the engine (hence the term, “front cover”), but it will be understood that in other engine mounting schemes it might face the side of the vehicle (as in a transverse mounted engine) or the rear of the vehicle.

U.S. Pat. No. 6,435,154 discloses a front cover for an internal combustion engine that contains VCT controls integrated into the front cover. The controls include a variable force solenoid (VFS) and a cam position sensor located in front of, and operably connected to each cam phaser. In one embodiment of the disclosed concept, the front cover, once assembled, comprises a single unit having an electronic interface module (EIM), VFS units and cam position sensors integrated within the cover. The patent further discloses that each VCT control unit is in electronic communication with other VCT control units and to a single EIM, located at separate locations within the front cover, via a wiring harness.

These prior art solutions do not completely solve the problem of simplifying the complexity associated with the compilation of numerous inputs from sensors, processing these inputs, determining the optimum signal outputs, sending these output signals to the appropriate target actuators and then monitoring the results in real time.

### SUMMARY OF THE INVENTION

The present invention is a variable cam timing (VCT) control module that includes a rigid planar backplane for mounting thereto at least one cam position sensor, a driven outer cam sprocket sensor, at least one solenoid and a microcontroller. All of these components are interconnected by circuitry that is located between the backplane and a coplanar bracket that is spaced apart from the backplane. The VCT control module may be located within the front cover of the engine or under the cam cover. It also contains a connector that protrudes through the surface of either the cam cover or the front cover of the engine. The connector provides the power and ground contacts with the engine electrical system, as well as the Controller Area Network (hereinafter, “CAN”) input and output signals. The CAN is the engine's controller communication network for the vehicle.

### BRIEF DESCRIPTION OF THE DRAWINGS

FIG. 1 shows an isometric view of the non-interface side of the VCT control module of the present invention.

FIG. 2 shows an isometric view of the interface side of the VCT control module.

FIG. 3 shows an exploded view of the VCT control module.

FIG. 4a shows the outside of an engine cam cover with the VCT control module connector extending through the surface of the cam cover.

FIG. 4b is an inverted view showing the inside of the cam cover with the VCT control module.

FIG. 5 shows the inside of a front engine cover with two VCT control modules each positioned each positioned at the front end of each cam bank in a “V” type dual overhead cam engine.

FIG. 6 is a schematic of the electrical circuitry of the VCT control module of the present invention.

### DETAILED DESCRIPTION OF THE INVENTION

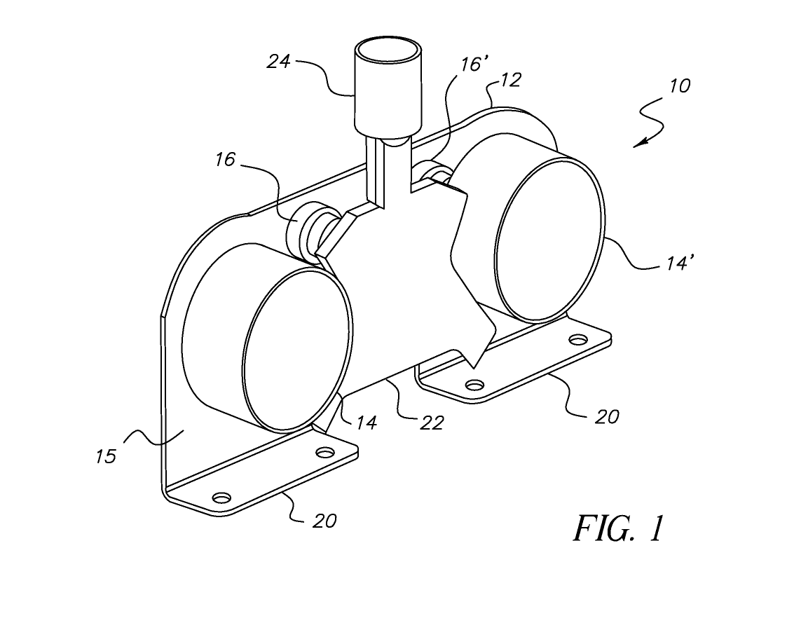

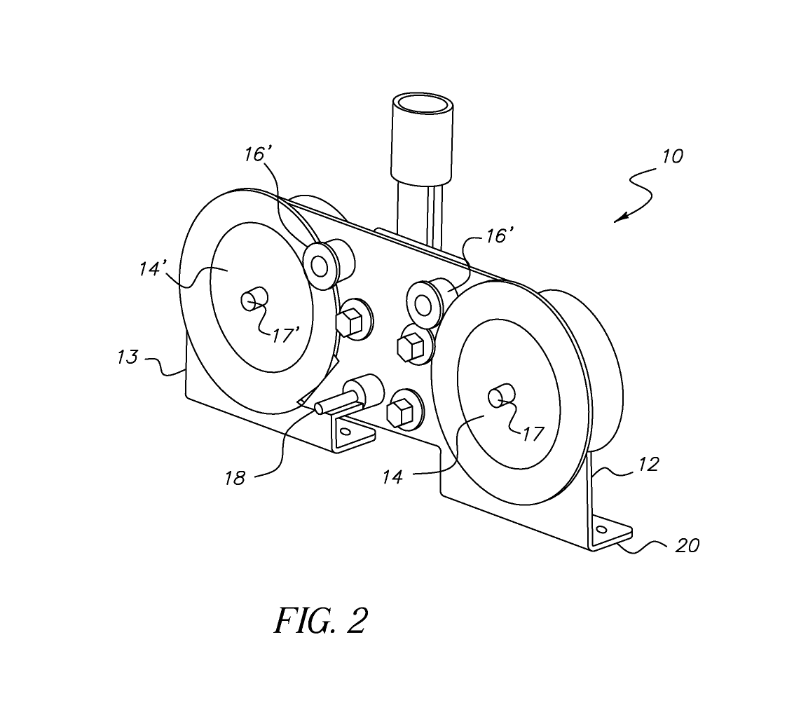

FIGS. 1 and 2 show a variable cam timing control (“VCT”) control module 10 according to the present invention. It contains a backplane 12 that is the primary support structure for mounting the various components of the VCT control module. The VCT components are securely mounted to the rear surface 15 of backplane 12. The VCT components include at least one solenoid 14 (14′), at least one cam position sensor (for example, a Hall effect, Magneto-resistive or Variable reluctance sensor) 16 (16′) and a driven outer cam sprocket sensor 18 (which provides a signal that is referenced to the crankshaft position through the chain, belt or gear).

The front surface 13 of the backplane 12 faces the cam phasing device(s), or phaser(s), not shown. Each phaser is operatively connected to a single camshaft. Each solenoid 14 and 14′ has a moveable piston 17 and 17′, respectively, which projects through the front surface 13 of the backplane 12 to functionally contact and regulate its respective phaser. The preferred solenoid is a variable force solenoid (VFS).

It will be understood by one skilled in the art that the VCT control module of the invention can be used with various internal combustion engine configurations. For example, a single cam “in line” engine would have only one cam. In this instance, the VCT control module would have only one cam position sensor and only one solenoid for actuating a single phaser, in addition to the driven outer cam sprocket sensor and the microcontroller. An in-line engine having two cams, one for controlling the intake valves and one for controlling the exhaust valves of the pistons, would require a VCT control module having two solenoids and two cam position sensors. A “V-type” engine configuration having two cams for each of the two “banks” of pistons is known as a dual overhead cam (or “DOHC”) engine, which would require two VCT control modules, one for each of the two banks of pistons, with each VCT control module having two solenoids and two cam position sensors, in addition to the driven outer cam sprocket sensor and the microprocessor. As this is a very prevalent engine design today, the appended Figures show a VCT control module that would be appropriate for use with a DOHC engine configuration.

The backplane 12 contains means 20 for mounting the VCT control module 10 securely to the engine housing, not shown. The mounting means 20 may be formed as an integral part of the backplane 12, as shown in FIGS. 1 and 2 or it may be secured to backplane 12 by known conventional means such as by the use of rivets, bolts or welds, as desired.

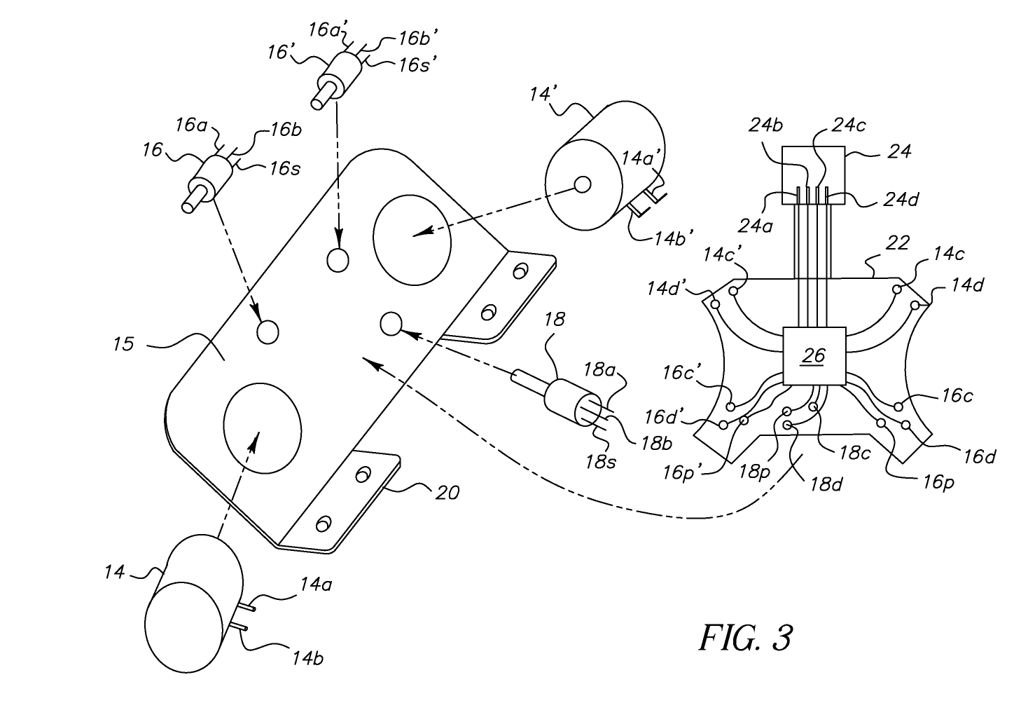

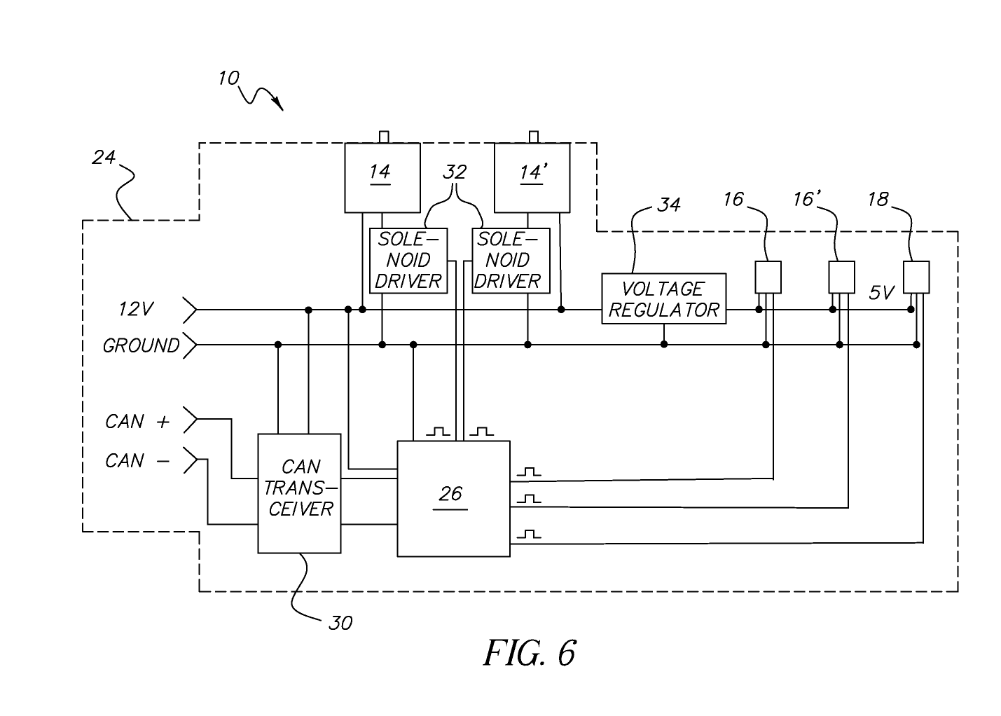

A planar bracket 22 is mounted substantially coplanar with and spaced apart from the rear surface 15 of backplane 12 and is positioned between the solenoids 14 and 14′. The bracket 22 contains the signal conditioning circuitry required to operate the VCT control module 10 and is best shown in the exploded view of the VCT control module in FIG. 3. The signal conditioning circuitry includes electrically conductive wires that connect to input and output terminals. Through these wires the VCT components are electrically connected to a microcontroller 26 that is mounted between the rear surface 15 of backplane 12 and bracket 22 to protect it from the harsh environment of the engine. The bracket 22 also includes a rigid connector housing 24 that contains plugs 24a and 24b, respectively, for connecting to the power and ground circuits of the engine electrical power grid, as well as an input plug 24c and an output plug 24d for respectively receiving and transmitting Control Area Network (“CAN”) bus signals. The signal conditioning circuitry of the present invention is shown in FIG. 6 and will be discussed in more detail later.

The input, output and signal terminals of the VCT components are connected to the signal conditioning circuitry by any conventional means such as by soldering the wire connections together or by inserting conventional male input and output terminals of the VCT components into conventional female ports within the bracket 22. In the exploded view shown in FIG. 3, input and output terminals 14a and 14b, respectively, of solenoid 14 are securely attached to ports 14c and 14d, respectively. Input and output terminals 14a′ and 14b′, respectively, of solenoid 14′ are securely attached to ports 14c′ and 14d′, respectively. Input, output and signal terminals 16a, 16b and 16s, respectively, of cam position sensor 16 are securely attached to ports 16c, 16d and 16p, respectively. Input, output and signal terminals 16a′, 16b′ and 16s′, respectively, of cam position sensor 16′ are securely attached to ports 16c′, 16d′ and 16p′, respectively. Input, output and signal terminals 18a, 18b and 18s, respectively, of the driven outer cam sprocket sensor 18 are securely attached to ports 18c, 18d and 18p, respectively. Electrically conductive wires connect each of the ports to the microcontroller 26, which in turn, is connected to the engine's power supply and the engine's communication bus or CAN bus through plugs 24a, 24b, 24c and 24d, respectively.

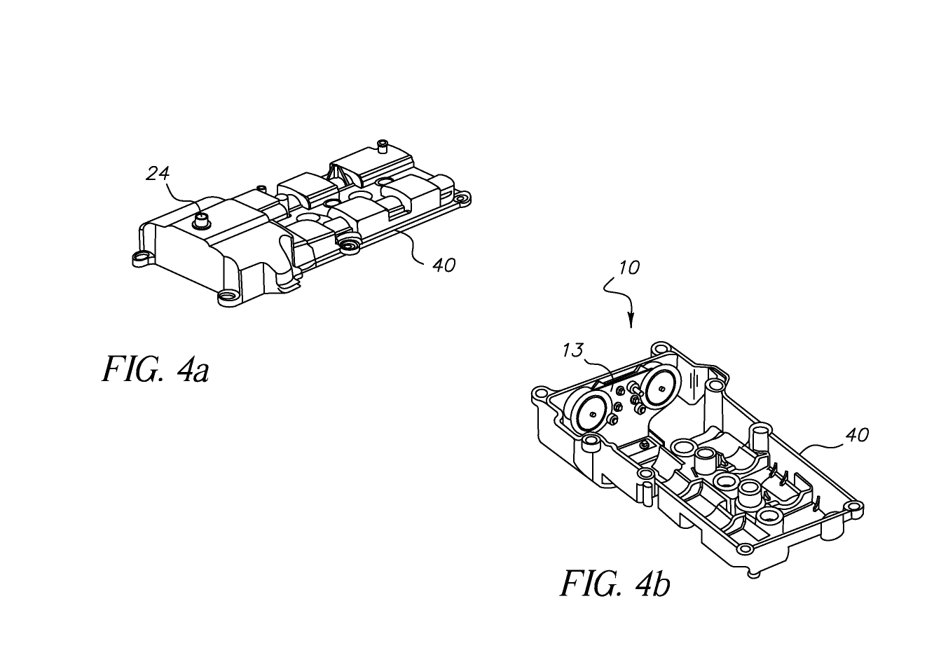

FIG. 4a shows the outside of cam cover 40 with VCT control module 10 mounted within. Protruding from an opening in the top surface of cam cover 40 is connector housing 24. FIG. 4b shows the VCT control module 10 securely mounted inside the cam cover 40. The front surface 13 of the VCT control module 10 faces the phasers (not shown), each of which, in turn, is operatively connected to its corresponding camshaft (not shown) in a DOHC engine configuration. Contained within connector housing 24 are plugs 24a, 24b, 24c and 24d, which are used to connect the VCT control module to the engine's power supply and communication bus or CAN bus through a mating electrical terminal connector (not shown). Within the context of the present invention, an alternate embodiment includes the connector housing 24 angled to project through an opening in the surface of the front cover, as may be required by the specific design parameters of different engines.

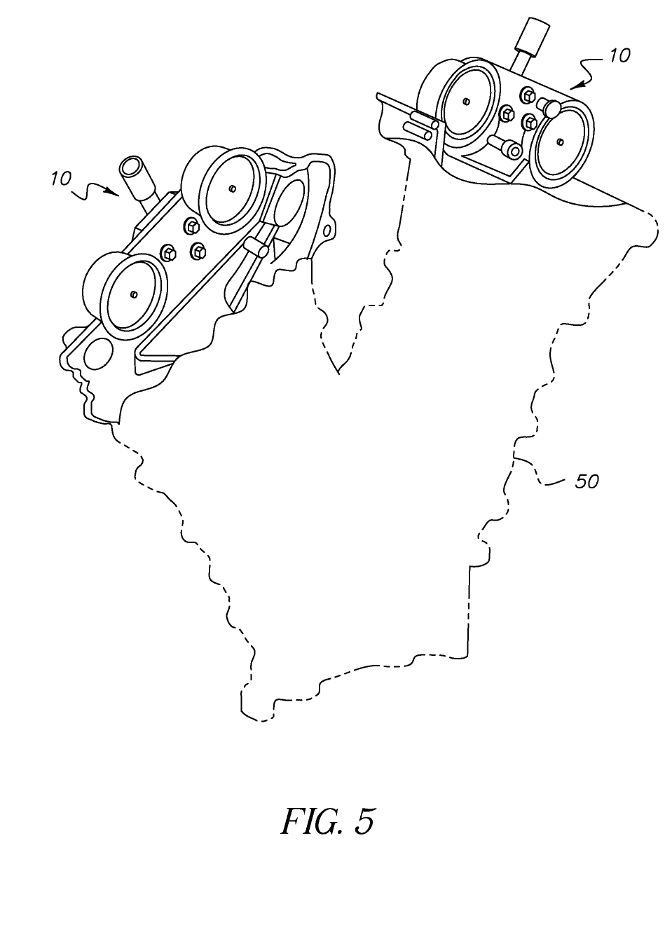

A “V” type engine has at least two camshafts (one for each bank of cylinders). Most V type engines today have four camshafts (intake and exhaust cams for each of the two banks of cylinders). These are referred to as dual overhead cam engines. FIG. 5 shows two separate VCT control modules 10 and 10′ mounted at the top of the front engine cover 50 adjacent each cam bank in a dual overhead cam engine.

FIG. 6 is a schematic diagram of the signal conditioning circuitry of the VCT control module 10. Solenoids 14 and 14′, cam position sensors 16 and 16′, and the driven outer cam sprocket sensor 18 are powered by the engine's electrical system. Within connector housing 24 are plugs for connecting to the engine electrical power grid. These plugs are a 12 volt input 24a, a ground 24b, a CAN+ bus input 24c and a CAN bus output 24d. The CAN signals are filtered through a CAN transceiver 30. The solenoids, CAN circuitry and microcontroller operate at 12 volts. However, the sensors operate at 5 volts. Therefore, a voltage regulator 34 reduces the voltage input into the cam position sensors 16 and 16′ and the driven outer cam sprocket sensor 18 from 12 volts to 5 volts.

In operation, a phase angle set point signal is sent from the ECU (not shown) to the microcontroller 26 via the CAN+ input plug 24c. Signals are also simultaneously received by the microcontroller 26 from the cam position sensors 16 and 16′ and the driven outer cam sprocket sensor 18. The microcontroller determines the proper cam phase angle in response to these inputs and then sends a signal to the solenoid drivers 32 and 32′ to command their respective solenoids 14 and 14′ to adjust the phasers so that the cam phase angle matches the commanded set point.

A further embodiment of the above outlined control scheme involves the microcontroller 26 of the VCT control module 10 sending a measured phase angle to the engine's ECU. The ECU then sends a command signal via the CAN circuit to the VCT control module which, in turn, then sends a signal to command selected solenoid drivers to actuate their respective phasers. The phasers then adjust their corresponding cams to the desired phase angle.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A variable cam timing control module for regulating cam phasing devices within a power transmission system of an internal combustion engine, each of the phasing devices being operatively engaged with a camshaft of the internal combustion engine, the variable cam timing control module comprising:
a) a planar rigid backplane, having a front surface and a rear surface, wherein the front surface faces the cam phasing devices,
b) a planar bracket spaced apart from and securely mounted to and substantially coplanar with the rear surface of the rigid backplane,
c) at least one solenoid, securely mounted to both the rear surface of the rigid backplane and the planar bracket, wherein a moveable piston from the solenoid protrudes through a hole in the rigid backplane to operatively engage the cam phasing device,
d) at least one cam position sensor, securely mounted to both the rear surface of the rigid backplane and the planar bracket, wherein a detector from the cam position sensor detects the position of the cam through a hole in the rigid backplane,
e) a crankshaft referenced driven outer cam sprocket sensor, securely mounted to both the rear surface of the rigid backplane and the planar bracket, wherein a detector from the driven outer cam sprocket sensor detects the position of the driven outer cam sprocket by detecting the position of the power transmission drive device through a hole in the rigid backplane, and
f) a microcontroller, securely mounted to the planar bracket between the rear surface of the rigid backplane and the planar bracket.

2. The variable cam timing control module of claim 1 wherein the control module is located inside a cam cover of the internal combustion engine.

3. The variable cam timing control module of claim 1 further comprising a connector housing that contains plugs for connection to an electrical power grid and a Controller Area Network of the internal combustion engine.

4. The variable cam timing control module of claim 3 wherein the connector housing protrudes from an opening in a surface of the cam cover.

5. The variable cam timing control module of claim 1 wherein the control module is located inside a front cover of the internal combustion engine.

6. The control module of claim 1 wherein the microcontroller is electrically connected to the at least one cam position sensor, the at least one solenoid, the at least one driven outer cam sprocket position sensor and an Electronic Control Unit of the internal combustion engine.

7. The control module of claim 1 wherein the solenoid is a variable force solenoid.

8. A method to control a phase angle of a cam of an internal combustion engine comprising the steps of:
a) sending an electronic signal from an Electronic Control Unit of the internal combustion engine to a microcontroller of a variable cam timing control module, wherein said signal identifies a desired set point angle, said variable cam timing control module further comprising at least one cam position sensor, at least one solenoid and a driven outer cam sprocket position sensor; wherein each of at least one solenoid is operatively connected to a cam phasing control device,
b) comparing input signals from the at least one cam position sensor and the driven outer cam sprocket position sensor with the set point angle signal; and
c) sending a control signal from the microcontroller to actuate the at least one solenoid to adjust the cam phasing control device so that the cam phase angle matches the desired set point angle.

9. The method of claim 8 wherein the solenoid is a variable force solenoid.

10. A method to control a phase angle of a cam of an internal combustion engine having a variable cam timing control module mounted on a cam phasing control device which is operatively engaged with the cam, the variable cam timing control module comprising at least one cam position sensor, at least one solenoid, a driven outer cam sprocket position sensor and a microcontroller, said method comprising the steps of:
a) calculating a phase angle based on input signals from the at least one cam position sensor and the driven outer cam sprocket position sensor,
b) sending a signal identifying the calculated phase angle to an Electronic Control Unit of the engine; and
c) sending a command signal to actuate the at least one solenoid to adjust the cam phasing control device so that the cam phase angle matches the calculated phase angle.

11. The method of claim 10 wherein the microcontroller calculates the phase angle.

12. The method of claim 10 wherein the solenoid is a variable force solenoid.
